(19) United States
(12) Patent Application Publication
(10) Pub. No.: US 2024/0077404 A1
(43) Pub. Date: Mar. 7, 2024

(54) AIR FILTRATION MONITORING SYSTEM

(71) Applicant: Donaldson Company, Inc., Bloomington, MN (US)

(72) Inventor: Brent R. Nelson, Savage, MN (US)

(21) Appl. No.: 18/139,865

(22) Filed: Apr. 26, 2023

Related U.S. Application Data
(60) Provisional application No. 63/336,610, filed on Apr. 29, 2022.

(51) Int. Cl. G01N 15/08; B01D 46/00; B01D 46/44

(52) U.S. Cl. CPC G01N 15/0826; B01D 46/0086; B01D 46/446; G01N 2015/084

(57) ABSTRACT

Embodiments herein relate to air filtration monitoring systems that can measure air volume and/or air velocity. In an embodiment a monitoring system for industrial dust collectors is included having a pressure sensor and a control circuit, wherein the control circuit can be in signal communication with the pressure sensor. The monitoring system can store a previously measured air volume value and/or air velocity value and can calculate real time air volume values and/or real time air velocity values using data from the pressure sensor and the previously measured air volume value and/or air velocity value. Other embodiments are also included herein.

This application claims the benefit of U.S. Provisional Application No. 63/336,610, filed Apr. 29, 2022, the content of which is herein incorporated by reference in its entirety.

### FIELD

Embodiments herein relate to monitoring devices for filtration systems. More specifically, embodiments herein relate to monitoring systems that can measure air volume and/or air velocity.

### BACKGROUND

A variety of fluid filtration systems have been developed for particulate and contaminant removal. In some scenarios, systems for cleaning an air or other gas stream laden with particulate matter include air filter assemblies that have filter elements disposed in a housing. The filter element can take various form including a bag, a sock, or a cartridge including a suitable filter media, e.g., fabric, pleated paper, etc. In operation, a gas stream contaminated with particulate matter is typically passed through the housing so that the particulate matter is captured and retained by one or more filter elements. Such filtration systems work quite reliably. However, needs for maintenance arise periodically. Further, sometimes events may occur causing systems to perform at less than expected levels.

### SUMMARY

Embodiments herein relate to air filtration monitoring systems that can measure air volume and/or air velocity. In a first aspect, a monitoring system for industrial dust collectors is included having a pressure sensor and a control circuit, wherein the control circuit can be in signal communication with the pressure sensor. The monitoring system can store a previously measured air volume value and/or air velocity value and can calculate real time air volume values and/or real time air velocity values using data from the pressure sensor and the previously measured air volume value and/or air velocity value.

In a second aspect, in addition to one or more of the preceding or following aspects, or in the alternative to some aspects, the monitoring system can calculate a real time value for air volume and/or air velocity by multiplying the previously measured air volume value and/or air velocity value by the square of the quotient of a current relative airflow value divided by a relative airflow value measured at the time of the previously measured air volume and/or air velocity. Relative airflow values can be derived using data from the pressure sensor.

In a third aspect, in addition to one or more of the preceding or following aspects, or in the alternative to some aspects, the monitoring system can calculate a real time value for air volume and/or air velocity by multiplying the previously measured air volume value and/or air velocity value by the square of the quotient of a current pressure value divided by a pressure value measured at the time of the previously measured air volume and/or air velocity.

In a fourth aspect, in addition to one or more of the preceding or following aspects, or in the alternative to some aspects, the pressure sensor can include a static pressure sensor.

In a fifth aspect, in addition to one or more of the preceding or following aspects, or in the alternative to some aspects, the static pressure sensor can be configured to measure pressure within a main duct portion of the industrial dust collector.

In a sixth aspect, in addition to one or more of the preceding or following aspects, or in the alternative to some aspects, the static pressure sensor can be configured to measure pressure within a branch of a main duct of the industrial dust collector.

In a seventh aspect, in addition to one or more of the preceding or following aspects, or in the alternative to some aspects, the static pressure sensor can be configured to measure pressure within a duct of the industrial dust collector upstream from an air filter.

In an eighth aspect, in addition to one or more of the preceding or following aspects, or in the alternative to some aspects, the static pressure sensor can be configured to measure pressure within a duct of the industrial dust collector or in fluid communication with the industrial dust collector having a diameter of 4 to 48 inches.

In a ninth aspect, in addition to one or more of the preceding or following aspects, or in the alternative to some aspects, the pressure sensor can be configured to be mounted on, mounted in, and/or mounted in fluid communication with an industrial dust collector.

In a tenth aspect, in addition to one or more of the preceding or following aspects, or in the alternative to some aspects, the pressure sensor can include a plurality of static pressure sensors, wherein the plurality of static pressure sensors can be configured to measure pressure within air ducts associated with different industrial air collectors.

In an eleventh aspect, in addition to one or more of the preceding or following aspects, or in the alternative to some aspects, the monitoring system can be configured to issue an alert if the real time air volume values and/or real time air velocity values are outside of a target range.

In a twelfth aspect, in addition to one or more of the preceding or following aspects, or in the alternative to some aspects, the system can be configured to receive input from a system user regarding the target range.

In a thirteenth aspect, in addition to one or more of the preceding or following aspects, or in the alternative to some aspects, the monitoring system can be configured to issue an alert if the real time air volume values and/or real time air velocity values are outside of a target range regardless of relative airflow values.

In a fourteenth aspect, in addition to one or more of the preceding or following aspects, or in the alternative to some aspects, the previously measured air volume and/or air velocity can be input into the system based on a measurement taken manually.

In a fifteenth aspect, in addition to one or more of the preceding or following aspects, or in the alternative to some aspects, the previously measured air volume and/or air velocity can be input into the system based on a measurement taken using at least one of a pitot tube, a vane anemometer, or a hotwire anemometer.

In a sixteenth aspect, in addition to one or more of the preceding or following aspects, or in the alternative to some aspects, the monitoring system can be configured to transmit real time data to a remote computing resource.

In a seventeenth aspect, in addition to one or more of the preceding or following aspects, or in the alternative to some aspects, the real time data can include at least one selected from the group consisting of real time pressure data, real time air volume values, and real time air velocity values.

In an eighteenth aspect, in addition to one or more of the preceding or following aspects, or in the alternative to some aspects, the real time air volume values can be in the range of 500 cfm (cubic feet per minute) to 50,000 cfm.

In a nineteenth aspect, in addition to one or more of the preceding or following aspects, or in the alternative to some aspects, the pressure sensor and the control circuit can be co-located with an industrial dust collector being monitored.

In a twentieth aspect, in addition to one or more of the preceding or following aspects, or in the alternative to some aspects, the pressure sensor and the control circuit can be located remotely from one another.

In a twenty-first aspect, a method of monitoring industrial dust collectors can be included. The method can include storing a previously measured air volume value and/or air velocity value, measuring real time pressure values in an area in fluid communication with an industrial air collector, and calculating real time air volume values and/or real time air velocity values using the real time pressure values and the previously measured air volume value and/or air velocity value.

In a twenty-second aspect, in addition to one or more of the preceding or following aspects, or in the alternative to some aspects, the method can further include measuring real time pressure values within a main duct portion of the industrial dust collector.

In a twenty-third aspect, in addition to one or more of the preceding or following aspects, or in the alternative to some aspects, the method can further include measuring real time pressure values within a branch off of a main duct of the industrial dust collector.

In a twenty-fourth aspect, in addition to one or more of the preceding or following aspects, or in the alternative to some aspects, the method can further include measuring real time pressure values within a duct of the industrial dust collector upstream from an air filter.

In a twenty-fifth aspect, in addition to one or more of the preceding or following aspects, or in the alternative to some aspects, the method can further include measuring real time pressure values within a duct of the industrial dust collector or in fluid communication with the industrial dust collector having a diameter of 4 to 48 inches.

In a twenty-sixth aspect, in addition to one or more of the preceding or following aspects, or in the alternative to some aspects, a pressure sensor can be mounted on, mounted in, and/or mounted in fluid communication with the industrial dust collector.

In a twenty-seventh aspect, in addition to one or more of the preceding or following aspects, or in the alternative to some aspects, the method can further include measuring pressure within air ducts associated with different industrial air collectors.

In a twenty-eighth aspect, in addition to one or more of the preceding or following aspects, or in the alternative to some aspects, the method can further include issuing an alert if the real time air volume values and/or real time air velocity values are outside of a target range.

In a twenty-ninth aspect, in addition to one or more of the preceding or following aspects, or in the alternative to some aspects, the method can further include receiving input from a system user regarding a target range.

In a thirtieth aspect, in addition to one or more of the preceding or following aspects, or in the alternative to some aspects, the method can further include issuing an alert if the real time air volume values and/or real time air velocity values are outside of a target range regardless of relative airflow values.

In a thirty-first aspect, in addition to one or more of the preceding or following aspects, or in the alternative to some aspects, the method can further include transmitting real time data to a remote computing resource.

In a thirty-second aspect, in addition to one or more of the preceding or following aspects, or in the alternative to some aspects, the real time data can include at least one selected from the group consisting of real time pressure values, real time air volume values, and real time air velocity values.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a schematic front perspective view of an air filtration system in accordance with various embodiments herein.

FIG. 2 is a schematic rear perspective view of an air filtration system with a monitoring system in accordance with various embodiments herein.

FIG. 3 is a schematic cross-sectional view of some aspects of an air filtration system in accordance with various embodiments herein.

FIG. 4 is a schematic diagram is shown of elements of a monitoring device in accordance with various embodiments herein.

FIG. 5 is a graph showing relative airflow of an industrial dust collector over time.

FIG. 6 is a graph showing relative airflow of an industrial dust collector over time.

FIG. 7 is a schematic diagram of portions of an industrial dust collector with monitoring capabilities in accordance with various embodiments herein.

FIG. 8A is a schematic diagram of portions of an industrial dust collector system with a monitoring system in accordance with various embodiments herein.

FIG. 8B is a schematic diagram of portions of an industrial dust collector system with a monitoring system in accordance with various embodiments herein.

FIG. 9 is a schematic front perspective view of an air filtration system with a monitoring system in accordance with various embodiments herein.

FIG. 10 is a schematic diagram is shown of elements of a filtration monitoring device in accordance with various embodiments herein.

FIG. 11 is a schematic view is shown of a filtration system data communication environment in accordance with various embodiments herein.

FIG. 12 is a schematic view is shown of a filtration system data communication environment in accordance with various embodiments herein.

FIG. 13 is a schematic front perspective view of an air filtration system with a monitoring device in accordance with various embodiments herein.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

As described above, there are many scenarios in which filtering dust, particulate matter, or other contaminants out of fluid streams is useful and there are many different types of filtration systems to accomplish the same. As an example, one type of an air filtration system (or industrial dust collector) has a clean air chamber (or clean/downstream side) and a dirty air chamber (or dirty/upstream side). The two chambers can be separated by a structure that can be referred to as a tube sheet. In many cases, the tube sheet has a number of openings so that air can pass between the clean and dirty air chambers. The filter elements can be positioned over the openings so that particulate-laden air (dirty air) introduced into the dirty air chamber must pass through a filter element to move into the clean air chamber. The particulate matter in the dirty air collects on the filter elements as the air moves through the filter elements. From the clean air chamber, the cleaned air is exhausted into the environment, or recirculated for other uses.

Industrial air filtration systems/dust collector systems are typically designed to operate at a particular level of air volume movement. For example, a particular dust collector system may be designed to operate in a specific plant at a volume of 4000 cfm. The designed volume can vary based on many different factors such as the size of the plant, the type of particulates being generated within the plant, the number of other filtration systems present, the safety factor designed into the system, and the like. Regardless, an insufficient volume (e.g., a volume below the designed volume) of air moving through the dust collector system can mean that dust/particulates are accumulating in various places such as within air ducts, at a particular site, in a piece of equipment, and/or in the air. Accumulating dust/particulates can lead to various environmental, health and safety issues that a plant may need to address.

Measurements of relative air flow, while useful for some purposes, can be insufficient in isolation as relative air flow could be substantially unchanging over time, but air volume could still he at an undesirable level. Therefore, it can be important to monitor the volume of air moving through the air filtration system to ensure proper system operation.

Unfortunately, real time air volume measurements can be impractical to make. Typical air volume measurement devices/sensors such as pitot tubes, vane anemometers, or hotwire anemometers are generally not feasible (complexity, cost, reliability, etc.) for ongoing real-time measurements in industrial dust collectors.

However, embodiments of monitoring systems herein can be used to reliably measure air volume in real time within dust collector systems in the field. In various embodiments, monitoring systems for industrial dust collectors are included herein having a pressure sensor and a control circuit in signal communication with the pressure sensor. The monitoring systems can store a previously measured air volume value and/or air velocity value and then calculate real time air volume values and/or real time air velocity values using data from the pressure sensor and the previously measured air volume value and/or air velocity value.

In various embodiments, methods of monitoring industrial dust collectors are included. An exemplary method can include storing a previously measured air volume value and/or air velocity value, measuring real time pressure values in an area in fluid communication with an industrial air collector, and calculating real time air volume values and/or real time air velocity values using the real time pressure values and the previously measured air volume value and/or air velocity value. As used herein, the term “real-time” shall include both real-time and near real-time measurements wherein measurements of air volume and/or air velocity are provided immediately or almost immediately so that the current condition of the underlying systems can be monitored.

It will be appreciated that air velocity values can be converted to air volume values by multiplying air velocity by the cross-sectional area of a duct or other passage for air. As such, references herein to techniques of monitoring of air volume can also apply to air velocity and vice versa.

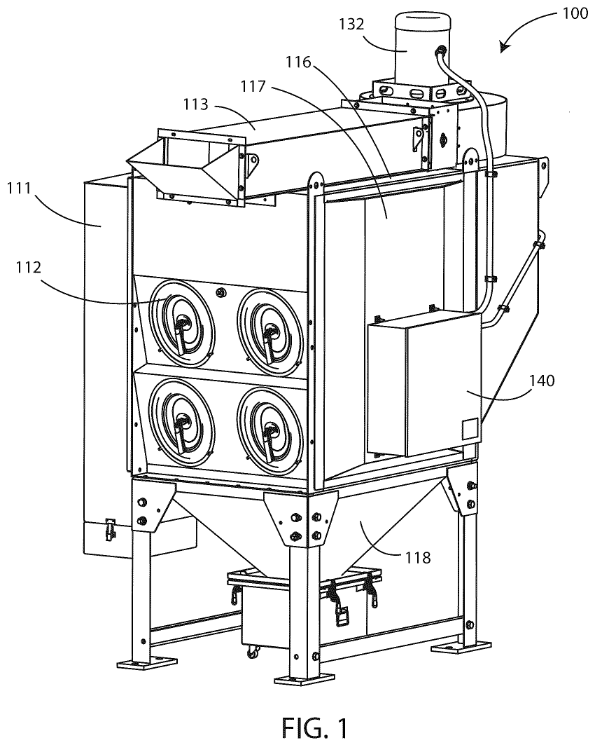

Referring now to FIG. 1, a schematic front perspective view is shown of an exemplary air filtration system 100 in accordance with various embodiments herein. In this example, the air filtration system 100 depicted in FIG. 1 is generally in the shape of a box and includes an upper wall panel 116, and two pairs of opposite side wall panels 117 (one of which is depicted in FIG. 1). It will be appreciated, however, that the air filtration system 100 can take on many different shapes and configurations.

The air filtration system 100 includes a dirty air conduit 111 for receiving dirty or contaminated air (i.e., air with dust/particulate matter therein) into the air filtration system 100. A clean air conduit 113 can be provided for venting clean or filtered air from the air filtration system 100. The air filtration system 100 includes access openings 112 for multiple filter elements (not shown in FIG. 1). In use, each of the access openings 112 is sealed by a cover (not shown) such that dirty air entering the air filtration system 100 does not escape through the access openings 112.

The air filtration system 100 may also include a hopper 118 to collect particulate matter separated from the dirty air stream as described herein. The hopper 118 may include sloped walls to facilitate collection of the particulate matter and may, in some embodiments, include a driven auger or other mechanism for removing the collected particulate matter.

In some embodiments, the air filtration system 100 can include a fan 132 to provide movement of air through the air filtration system 100. However, in other embodiments, air can be pulled through the system with a fan or other equipment that is not part of the air filtration system 100.

The air filtration system 100 can also include a preexisting control box 140, which can include a preexisting control circuit for control of the filtration system. In some embodiments, monitoring systems herein can be integrated with and/or in communication with the preexisting control box 140. However, in some embodiments, such as in some retrofit scenarios there is no electrical communication between the preexisting control box 140 and/or components therein such as a preexisting control circuit and a monitoring device herein. While not intending to be bound by theory, it is believed that this electronic separation can offer a security advantage as the preexisting control box 140 and components therein are responsible for operation of the filtration system 100 whereas the monitoring device is only responsible for monitoring of the filtration system 100. In this way, the monitoring device cannot be used as a means of gaining control over operation of the filtration system 100.

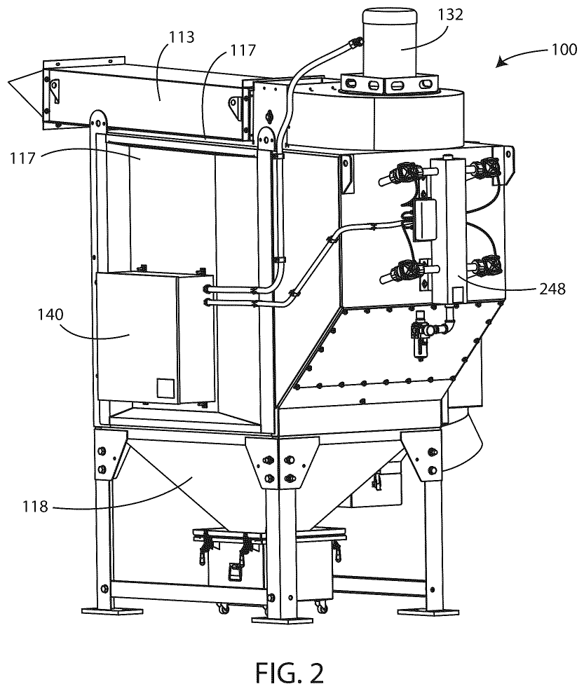

Referring now to FIG. 2, a schematic rear perspective view is shown of an air filtration system with a monitoring device in accordance with various embodiments herein. FIG. 2 shows many of the same elements as shown in FIG. 1, but from a rear perspective view. FIG. 2 also shows a compressed air manifold 248.

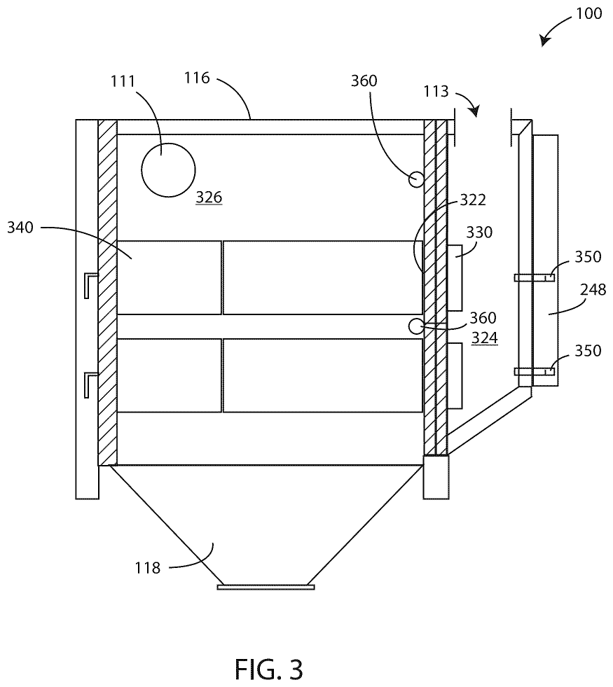

Referring now to FIG. 3, a schematic cross-sectional view is shown of some aspects of an exemplary air filtration system 100 in accordance with various embodiments herein. The interior of the air filtration system 100 includes a tube sheet 322 that separates the interior of the housing into a clean air chamber 324 and a dirty air chamber 326. The air filtration system 100 includes a clean air conduit 113 through which clean air exits from the clean air chamber 324 during operation of the air filtration system 100. The depicted air filtration system 100 includes filter elements 340 in the dirty air chamber 326 (dirty side or upstream side).

Pulse collectors 330 can be included and can be disposed within the clean air chamber and can be attached to and/or adjacent to the tube sheet 322 over an aperture in the tube sheet 322 (not seen in FIG. 3) such that a pulse of air from the pulse generators 350 passing through the pulse collector 330 enters an interior volume of the filter elements 340. Air can be provided to the pulse generators 350 from a compressed air manifold 248, which itself can receive compressed air from an air compressor or central source of plant compressed air. The release of air from the compressed air manifold 248 to the pulse generators 350 can be controlled by valves (pulse valves) which can be of various types including, but not limited to, diaphragm valves, solenoid valves, and other valves for controlling fluid flow.

In accordance with various embodiments herein, one or more pressure sensors can be placed at various points in or near the filtration system to provide pressure data from which real time air volume measurements can be made as described herein. For example, FIG. 3 depicts sensors 360 within dirty air chamber 326. However, in some embodiments, one or more pressure sensors can be located in area(s) of the air filtration system 100 other than a location shown in FIG. 3 (such as in air ducts in fluid communication with the filtration system). In some embodiments, the location for sensors described can, instead of physical sensor placement, refer to a location for which a sensor may be configured for detection. For example, the sensor itself may not actually be positioned in the particular area but may nonetheless produce data reflecting pressure values at such locations.

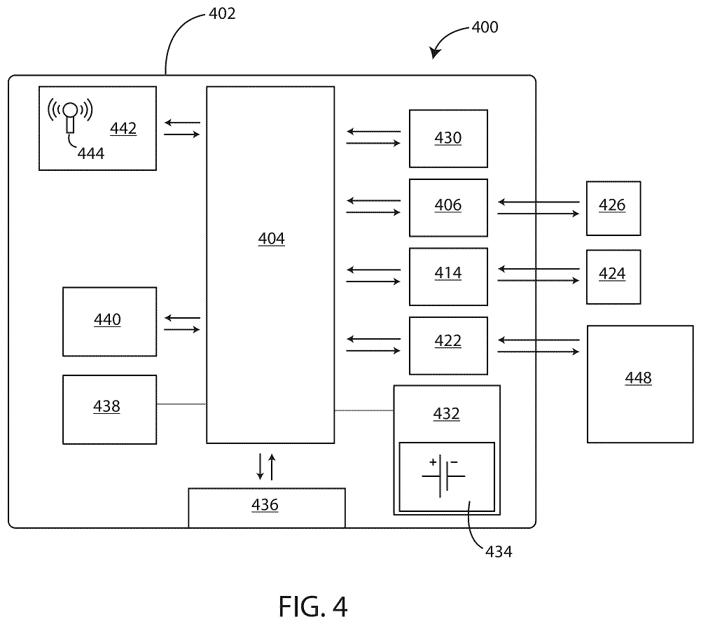

Referring now to FIG. 4, a schematic diagram is shown of elements of a monitoring device 400 in accordance with various embodiments herein. It will be appreciated that a greater or lesser number of components can be included with various embodiments and that this schematic diagram is merely illustrative. The monitoring device 400 can include a housing 402 and a control circuit 404. The control circuit 404 can include various electronic components including, but not limited to, a microprocessor, a microcontroller, a FPGA (field programmable gate array) chip, an application specific integrated circuit (ASIC), or the like.

In various embodiments, the monitoring device 400 can include a first pressure sensor 406 channel interface (as used herein, reference to a pressure sensor shall include a pressure transducer unless the context dictates otherwise) and a first pressure sensor 426. In various embodiments, the monitoring device 400 can optionally include a second pressure sensor 414 channel interface and a second pressure sensor 424. In various embodiments, the monitoring device 400 can optionally include other sensor channel interface(s) 422 and other sensor(s) 448.

Pressure sensors herein can be of various types. Pressure sensors herein can include, but are not limited to, static pressure sensors, differential pressure sensors, gauge pressure sensors, and the like. In various particular embodiments herein, one or more static pressure sensors are used. Pressure sensors herein can include those based on resistive, capacitive, piezoelectric, optical, metal thin-film, ceramic thick-film, and or MEMS components. Pressure sensors herein can also include diaphragm or and/or strain gauge-based designs.

In some embodiments, an additional sensor used herein can include a microphone. Microphones herein can include vibration sensors. Microphones and/or vibration sensors herein can be of various types including, but not limited to, unidirectional, omnidirectional, MEMS based microphones, piezoelectric microphones, magnetic microphones, electret condenser microphones, accelerometers, and the like.

In some embodiments, the monitoring device 400 can include one or more additional sensors, such as an accelerometer, temperature sensor, optical sensor, or the like. For example, in some embodiments the monitoring device 400 can include a 3-axis accelerometer 430.

In various embodiments, the monitoring device 400 can include a power supply circuit 432. In some embodiments, the power supply circuit 432 can include various components including, but not limited to, a battery 434, a capacitor, a power-receiver such as a wireless power receiver, a transformer, a rectifier, and the like.

In various embodiments the monitoring device 400 can include an output device 436. The output device 436 can include various components for visual and/or audio output including, but not limited to, lights (such as LED lights), a display screen, a speaker, and the like. In some embodiments, the output device can be used to provide notifications or alerts to a system user such as current system status, an indication of a problem, a required user intervention, a proper time to perform a maintenance action, or the like. In some embodiments, the output device can also be used as an input device, such as via a touch screen interface or another input modality. User inputs can include information regarding target ranges for air volume and/or air velocities, dust collector model information, configuration information, information regarding duct size, diameter or cross-sectional area, and the like.

In various embodiments the monitoring device 400 can include memory 438 and/or a memory controller. The memory can include various types of memory components including dynamic RAM (D-RAM), read only memory (ROM), static RAM (S-RAM), disk storage, flash memory, EEPROM, battery-backed RAM such as S-RAM or D-RAM and any other type of digital data storage component. In some embodiments, the electronic circuit or electronic component includes volatile memory. In some embodiments, the electronic circuit or electronic component includes non-volatile memory. In some embodiments, the electronic circuit or electronic component can include transistors interconnected to provide positive feedback operating as latches or flip flops, providing for circuits that have two or more metastable states, and remain in one of these states until changed by an external input. Data storage can be based on such flip-flop containing circuits. Data storage can also be based on the storage of charge in a capacitor or on other principles. In some embodiments, the non-volatile memory 438 can be integrated with the control circuit 404.

In various embodiments the monitoring device 400 can include a clock circuit 440. In some embodiments, the clock circuit 440 can be integrated with the control circuit 404. While not shown in FIG. 4, it will be appreciated that various embodiments herein can include a data/communication bus to provide for the transportation of data between components. In some embodiments, an analog signal interface can be included. In some embodiments, a digital signal interface can be included.

In various embodiment the monitoring device 400 can include a communications circuit 442. In various embodiments, the communications circuit can include components such as an antenna 444, amplifiers, filters, digital to analog and/or analog to digital converters, and the like.

In various embodiments, monitoring devices 400 herein are designed so that they can operate using only a battery for power and not deplete the battery for a long period of time such as weeks, months, or even years. As such, in various embodiments operations of the monitoring device 400 can be optimized to conserve energy consumption.

In some embodiments, the pressure sensor(s) generate signals continuously or substantially continuously. However, in some embodiments, the pressure sensor(s) generate signals discontinuously. In some embodiments, the pressure sensor(s) can generate signals at predetermined time intervals. In some embodiments, the pressure sensor(s) can generate signals according to a duty cycle. In some embodiments, the control circuit can initiate a change (transitory or otherwise) in sensor operation such as in the frequency with which sensor measurements are made and/or a change in the bandwidth or resolution of the sensor data. In some embodiments, the transitory change in the data recording parameter comprises increasing the bandwidth or resolution of the recorded data.

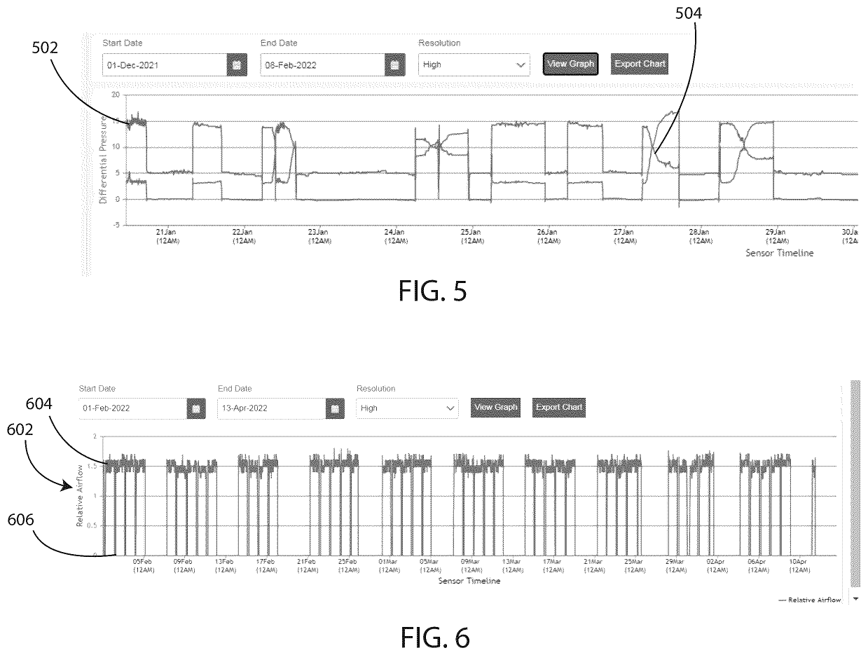

However, referring now to FIG. 5, a graph is shown illustrating relative airflow 502 through an industrial dust collector over time. In this view, it can be seen that the relative airflow 502 hits a point where flow declines 504 while the system is in use. This decline could be significant and indicate a need for system maintenance.

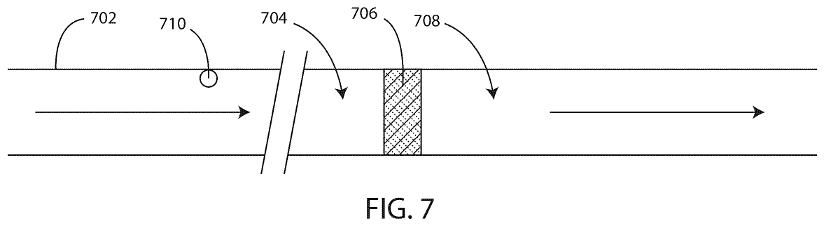

However, as referenced above, measurements of relative air flow, while useful for some purposes, can be insufficient in isolation as relative air flow could be substantially unchanging over time, but air volume could still be at an undesirable level. Therefore, it can be important to monitor the volume of air moving through the air filtration system to ensure proper system operation and safety. As an example, referring now to FIG. 6, a graph is shown illustrating relative airflow 602 of an industrial dust collector over time. In this view, it can be seen that the relative airflow oscillates between a higher level 604 when the system is in use and a lower level 606 (or off level) when the system is not in use. In this example, the relative airflow at the higher level 604 is stable and does not change substantially over time (e.g., the magnitude of the higher level 604 does not change substantially over time). However, just viewing the data in FIG. 6, there is no way of determining whether air volume and/or air velocity are at appropriate levels. Embodiments herein can be used to determine air volume and/or air velocity.

Pressure sensors used with systems herein can be positioned at various points within, adjacent to, or otherwise in fluid communication with air filtration systems such as industrial dust collectors. In various embodiments, pressure sensors can be positioned at a point that is upstream of (on the dirty side of) an air filter or filtration system. As such, in various embodiments, systems herein can use static pressure sensors can be positioned at a point that is upstream of (on the dirty side of) an air filter or filtration system. While the size of ducts in which air volume can be measured is not particularly limited, in some embodiments the monitoring system is configured to measure pressure within a duct of the industrial dust collector or in fluid communication with the industrial dust collector having a diameter of 4 to 48 inches.

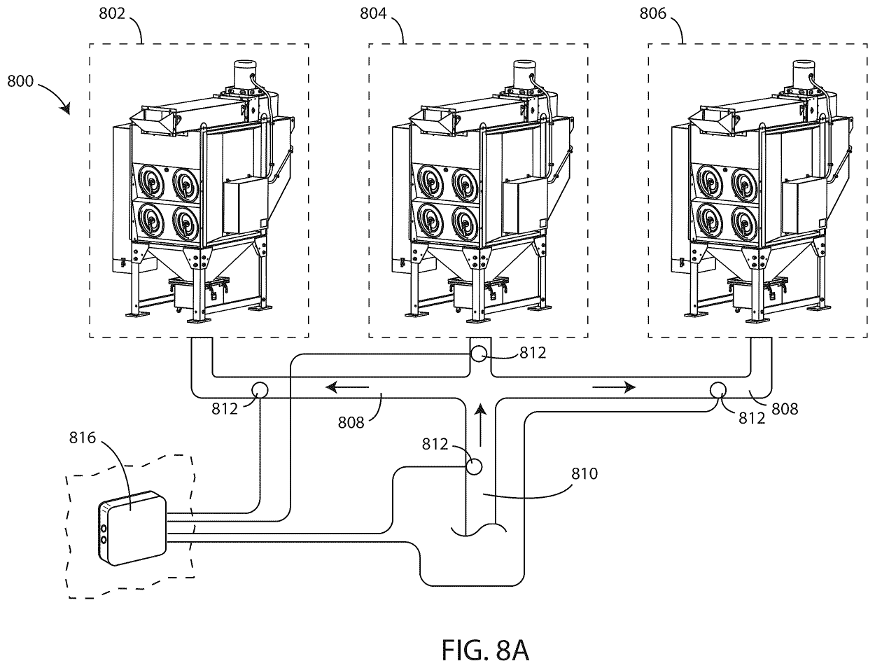

Referring now to FIG. 7, a schematic diagram is shown of portions of an industrial dust collector with monitoring capabilities in accordance with various embodiments herein. In this view, an air flow duct 702 is shown in fluid communication with an air filter 706 (which could represent one or more air filtration elements, cartridges, bags, or the like or an air filtration system). The air filter 706 divides the upstream or dirty side 704 from the downstream or clean side 708. In accordance with embodiments herein, a pressure sensor 710, such as a static pressure sensor, can be positioned within, adjacent to, or otherwise in fluid communication with the upstream or dirty side 704.

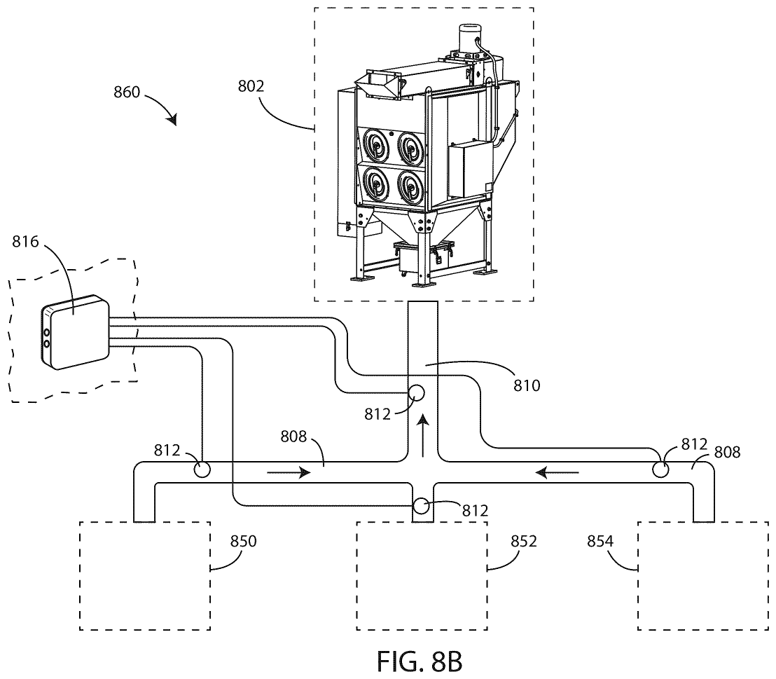

Referring now to FIG. 8A, a schematic diagram is shown of portions of an industrial dust collector system 800 with a monitoring system in accordance with various embodiments herein. In this example, the dust collector system 800 includes multiple individual dust collector units (802, 804, 806). Dust collector systems within a plant or at a particular location can include any number of individual units from one to ten or more. In this example, a main duct 810 conveys air laden with dust/particulates to branches 808. A monitoring system 816 can be in signal communication with pressure sensors 812 positioned in, adjacent to, or otherwise in fluid communication with the main duct 810 or any or all of the branches 808. Air volume and/or air velocity can be tracked in real-time within any portion of the system including a pressure sensor 812 such as within the main duct 810 or any or all of the branches 808.

Referring now to FIG. 8B, a schematic diagram is shown of portions of an industrial dust collector system 860 with a monitoring system in accordance with various embodiments herein. In this example, the dust collector system 800 includes a single dust collector unit 802, but multiple workstations or pieces of equipment (850, 852, 854) generating dust/particulates such as plasma cutters or another type of machine. In this example, branches 808 convey air laden with dust/particulates from the pieces of equipment (850, 852, 854) to the main duct 810 and then to the dust collector unit 802. A monitoring system 816 can be in signal communication with pressure sensors 812 positioned in, adjacent to, or otherwise in fluid communication with the main duct 810 or any or all of the branches 808 (or input ducts in this example). Air volume and/or air velocity can be tracked in real-time within any portion of the system including a pressure sensor 812 such as within the main duct 810 or any or all of the branches 808. In this manner, air volume and/or velocity can be monitored at the level of multiple individual workstations or pieces of equipment despite there being only one dust collector.

Accordingly, monitoring systems herein can track air volume at one or multiple points of a dust collector device or system allowing for detection/measurement of air volume across the system as a whole or within any subunits of the same. As such, in some embodiments, a static pressure sensor of the system can be configured to measure pressure within a main duct portion of the industrial dust collector. In some embodiments a static pressure sensor of the system can be configured to measure pressure within a branch of a main duct of the industrial dust collector. In some embodiments the monitoring system can include a plurality of static pressure sensors, wherein the plurality of static pressure sensors are configured to measure pressure within air ducts associated with different industrial air collectors or air ducts of the same industrial air collector.

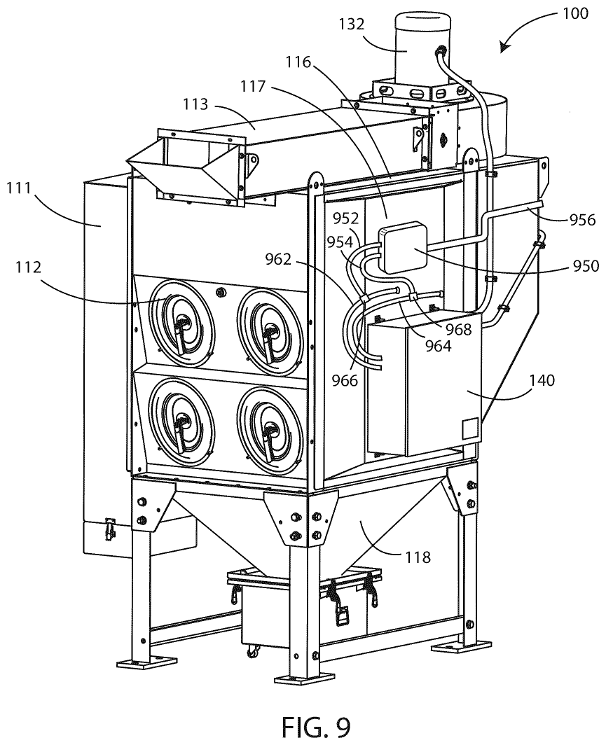

In some embodiments, such as in retrofit scenarios, monitoring systems herein can be connected to dust collector units/systems via one or more fluid conduits such that pressure sensors need not be mounted directly on or in the dust collector unit, but can be put into fluid communication with the same for purposes of pressure measurement or other sensing. Referring now to FIG. 9, a schematic front perspective view of an air filtration system with a monitoring system in accordance with various embodiments herein. FIG. 9 is generally similar to FIG. 1. However, FIG. 9 also shows monitoring device 950 that can be connected to a first fluid conduit 952, a second fluid conduit 954, and third fluid conduit 956. The fluid conduits can provide fluid communication between various parts of the filtration system (such as the dirty/upstream side, the clean/downstream side, a compressed air supply, etc.) and sensors/transducers that can be within or otherwise associated with the monitoring device 950. Thus, in such an embodiment, the sensors used may not be directly in such locations, but can be in fluid communication with such locations so that they can measure pressures in such locations. In some embodiments, the first fluid conduit 952 can be connected to an existing fluid conduit 962 of the air filtration system that provides fluid communication with an area of fluid flow that is upstream from the filtration element(s). In some embodiments, the first fluid conduit 952 can be connected to the existing fluid conduit 962 using a junction 966 (such as a T-junction, splice junction, or other connecting structure). The second fluid conduit 954 can be connected to an existing fluid conduit 964 of the air filtration system that provides fluid communication with an area of fluid flow that is upstream from the filtration element(s). In some embodiments, the second fluid conduit 954 can be connected to the existing fluid conduit 964 using a junction 968 (such as a T-junction, splice junction, or other similar connecting structure).

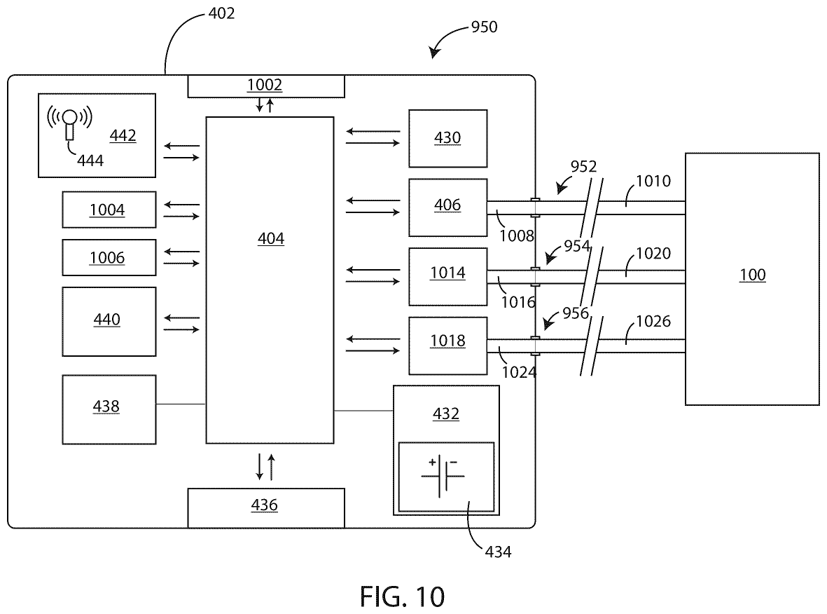

Referring now to FIG. 10, a schematic diagram is shown of elements of a monitoring device 950 in accordance with various embodiments herein. FIG. 10 includes various components as shown in FIG. 4. However, the embodiment depicted in FIG. 10 can also include first fluid conduit 952 (in fluid communication with the filtration system 100) including an internal portion 1008 and an external portion 1010, as well as a second fluid conduit 954 (in fluid communication with the filtration system 100) including an internal portion 1016 and an external portion 1020, and a third fluid conduit 956 (in fluid communication with the filtration system 100) including an internal portion 1024 and an external portion 1026.

In some embodiments, the monitoring device 950 can also include an input interface 1002 and/or user input device. The monitoring device 950 can also include a low-energy local wireless communication component 1004. In some embodiments, the low-energy local wireless communication component 1004 can include a Bluetooth component. In some embodiments, the system can be in communication with various sensors and/or devices that have sensors and exchange or receive data from the same through the low-energy local wireless communication component 1004. In some embodiments, the monitoring device 950 can also include a wired I/O interface 1006 and one or more wire connection ports or plug receptacles. In some embodiments, the system can be in communication with various sensors and/or devices that have sensors and exchange or receive data from the same through the wired I/O interface 1006.

In some embodiments, the monitoring device 950 can include various other sensors beyond a pressure sensor or a differential pressure sensor. In some embodiments, the monitoring device 950 can also include a temperature sensor 1014. The temperature sensor 1014 can be in fluid communication with at least one of the first fluid conduit, the second fluid conduit, and the third fluid conduit.

In some embodiments, the monitoring device 950 can also include a sound sensor 1018, such as a microphone or vibration sensor. In some embodiments, the sound sensor 1018 can be in fluid communication with at least one of the first fluid conduit, the second fluid conduit, and the third fluid conduit. In some embodiments, the monitoring device 950 can also include a humidity sensor.

In some embodiments, the pressure sensor and the control circuit are co-located with an industrial dust collector being monitored. However, in some embodiments, the pressure sensor and the control circuit are located remotely from one another.

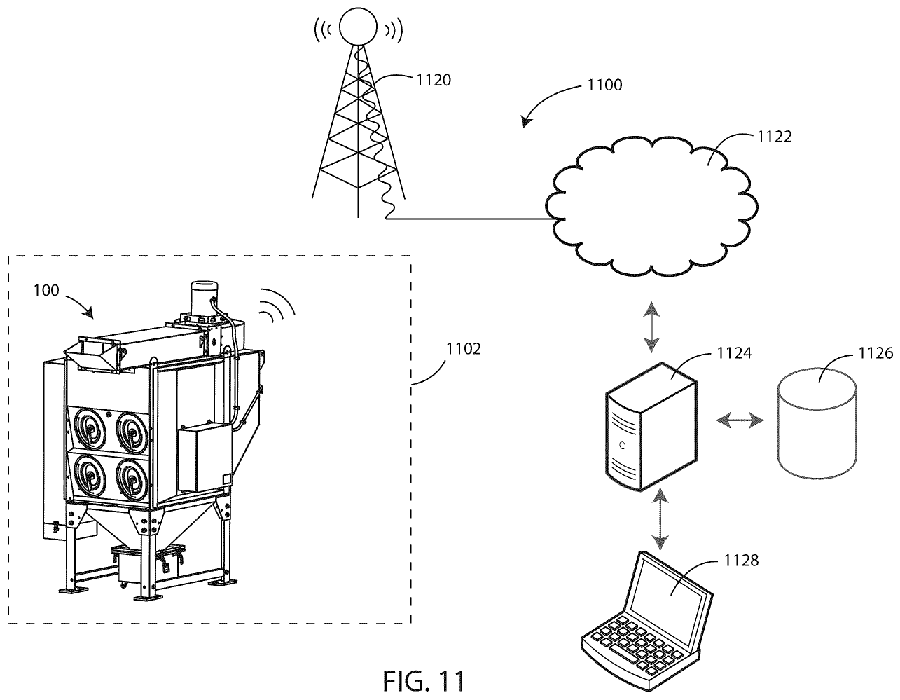

Referring now to FIG. 11, a schematic view is shown of a filtration monitoring system data communication environment 1100 in accordance with various embodiments herein. The communication environment 1100 can include an air filtration system 100, such as an industrial dust collector, a gas turbine filtration system, or another filtration system for various fluids including air. In some embodiments, the filtration system 100 can be within a work environment 1102. The work environment 1102 can represent a geographic area in which the air filtration system 100 operates. The work environment 1102 can be, for example, a shipping or distribution center, a manufacturing facility or factory, a power production plant, or the like.

In some embodiments, wireless signals from the filtration system 100 can be exchanged with a wireless communication tower 1120 (or antenna array), which could be a cellular tower or other wireless communication tower. The wireless communication tower 1120 can be connected to a data network 1122, such as the Internet or another type of public or private data network, packet-switched or otherwise.

The data network can provide for one-way or two-way communication with other components that are external to the work environment 1102. For example, a server 1124 or other processing device, or cloud computing resource, can receive electronic signals containing data from one or more components such as the filtration system 100. As such, in various embodiments, the monitoring system can be configured to transmit real time data to a remote computing resource. In various embodiments, the real time data comprising at least one selected from the group consisting of real time pressure data, real time air volume values, and real time air velocity values.

The server 1124 (real or virtual) can interface with a database 1126 (real or virtual) to store data. In some embodiments, the server 1124 (or a device that is part of the server system) can interface with a user device 1128, which can allow a user to query data stored in the database 1126 through a user interface. In specific, the user interface can include display of air volume and/or air velocity data. The server 1124 and/or the database 1126 can be at a distinct physical location or can be in the cloud.

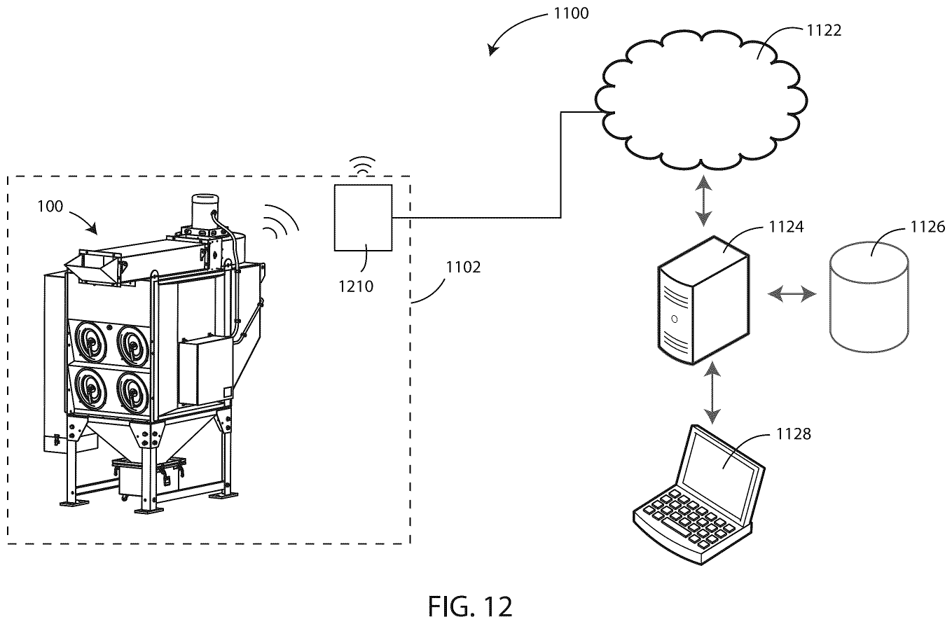

Referring now to FIG. 12, a schematic view is shown of a filtration system data communication environment 1100 in accordance with various embodiments herein. In some embodiments, a gateway or repeater unit 1210 can be disposed within the work environment 1102. The gateway or repeater unit 1210 can, in some embodiments, communicate wirelessly with the filtration system 100 and/or one or more sensors that gather data that can be used by the filtration system 100. In some embodiments, the gateway or repeater unit 1210 can be connected to an external data network 1122, such as the Internet or various private networks. In some embodiments, the data network 1122 can be a packet-switched network. In some embodiments, the gateway or repeater 1210 can also include data network router functionality.

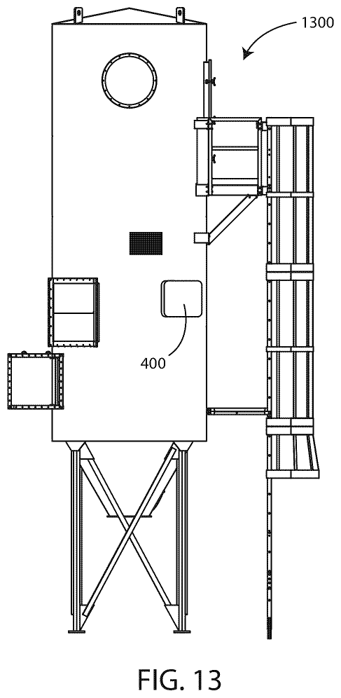

It will be appreciated that monitoring systems herein can work with many different types of filtrations systems. While previous figures herein such as FIGS. 1-3 illustrate a cartridge-based air filtration system, it will be appreciated that bag-type air filtration systems can also be monitored with monitoring systems herein. Referring now to FIG. 13, is a schematic front perspective view of an air filtration system 1300 with a filtration system monitoring device 400 in accordance with various embodiments herein. In this view, connections to the filtration system monitoring device 400 are not shown for ease of illustration. In operation, filter bags can be pulse cleaned periodically to maintain or reduce operating pressure drop, the filter bags tend to be pulse cleaned during operation. During a pulse cleaning operation, a pulse of air is directed through the filter bag in a direction opposite to normal filtering operations. The effect of the pulse of air has two important results. First, the pulse tends to cause the filter bag to flex in response to the increased internal pressure. Such outward flex movement tends to mechanically remove any build-up of particulate in the form of a filter cake on the exterior of the bag. Further, the increase in air flow in the opposite direction through the surface of the filter bag tends to cause the particulates to be removed by the action of the air passing through the porous openings within the filter bag structure. The result of the action of the air passing through the bag in an opposite direction during operations tends to reduce the quantity of any particulate or filter cake that forms on the exterior of the filter bag, thus returning the filter bag to a pressure drop that is typically more commensurate with efficient operation of the structure. Such pulse cleaning operations can be performed using a variety of internal structures within the bag house. The bag house can contain internal fans that can direct a stream of air in the opposite direction through the housing structure. Alternatively, the housing can contain an air orifice or spray head that can be installed within the support structure or can be moved from support structure to support structure to introduce a reverse pulse stream of air into the interior of the bag house. Monitoring devices herein can be connected to such filtration systems such that fluid communication is provided with areas of the filtration system (such as the clean or downstream side of the filter bags and the dirty or upstream side of the filter bags) and sensors in, or otherwise in electrical communication with, the monitoring device. Further aspects of bag-type air filtration systems are described in U.S. Pat. No. 6,740,412, the content of which is incorporated herein by reference.

### System Calculations and Volume/Velocity Calculation

In various embodiments, the monitoring system can be configured to measure a real time air volume and/or air velocity value using a real-time static pressure measurement along with data representing an initial measurement of air volume and a static pressure at the time of the initial measurement of air volume. For example, when an industrial dust collector or air filtration system is initially installed, measurements of air volume can be taken manually, such as with pitot tube, a vane anemometer, or a hotwire anemometer or another flow or velocity measurement device or technique, along with a measurement of static pressure at the same time. Alternatively, measurements of air volume can be taken manually during a configuration or calibration event along with a measurement of static pressure at the same time.

It will be appreciated that the measurement of static pressure at the same time need not be taken manually if it is tracked another way and can be linked via time stamp to the time when the air volume measurement is taken manually.

Equation 1 below shows the relationship between pressure measurements (real time and the initial/manual/calibration measurement), air volume as measured during the initial/manual/calibration measurement, and the real time air volume and can be used by the system herein to calculate air volume and/or air velocity.

$$QAct = QMeas * \sqrt{\frac{{Pressure}_{Act}}{{Pressure}_{Meas}}} \qquad ( Equation 1 )$$

Wherein:
Q_{Act}: The real time air volume.
Q_{Meas}: The air volume at the time of an initial/manual/calibration event.
Pressure_{Act}: The real time static pressure at the same site as where Pressure_{Meas} was measured.
Pressure_{Meas}: The static pressure at the time of the initial/manual/calibration measurement, typically on the dirty or upstream side of an air filter of the system.

As such, monitoring systems herein can calculate a real time value for air volume and/or air velocity by multiplying the previously measured air volume value and/or air velocity value by the square of the quotient of a current pressure value divided by a pressure value measured at the time of the previously measured air volume and/or air velocity. Alternatively, monitoring systems herein can calculate a real time value for air volume and/or air velocity by multiplying the previously measured air volume value and/or air velocity value by the square of the quotient of a current relative airflow value divided by a relative airflow value measured at the time of the previously measured air volume and/or air velocity, wherein relative airflow values are derived using data from the pressure sensor.

As previously described, it will be appreciated that air velocity values can be converted to air volume values by multiplying air velocity by the cross-sectional area of a duct or other passage for air. Conversely, air volume values can be converted to air velocity values by dividing air volume by the cross-sectional area of a duct or other passage for air.

In various embodiments, the control circuit can initiate an alarm and/or issue an alert if a predetermined alarm condition has been met. The alarm condition can include detection of a particular operational state or event of the filtration system. In some embodiments the alarm condition can include the detection of a real time air volume and/or real time air velocity crossing a threshold value and/or falling outside of a target range. In some embodiments, the monitoring system can be configured to receive input from a system user regarding the target range. In some embodiments, the monitoring system can be configured to issue an alert if the real time air volume values and/or real time air velocity values are outside of a target range regardless of relative airflow values (e.g., regardless of whether relative airflow values are staying substantially constant). The particular target range set is not particularly limited. However, air filtration systems monitored herein may commonly be designed with air volumes in the range of 500 cfm, 2,000 cfm, 5,000 cfm, 10,000 cfm, 20,000 cfm, 30,000 cfm, or 50,000 cfm or more, or an amount falling within a range between any of the foregoing.

In some embodiments, a multi-level alarm or alert threshold may be set. For example, when a real-time air volume or air velocity measurement crosses (such as falls below) a first threshold value, then an informational or less-urgent alarm or alert may be triggered wherein when a real-time air volume or air velocity measurement crosses a second threshold value, then an urgent alarm or alert may be triggered.

In various embodiments the control circuit can calculate a time for servicing of the system, and/or replacement of a filter element and/or generate a signal regarding the time for filter replacement. In various embodiments, the control circuit can calculate a time for servicing of the system and/or filter elements thereof and issue a notification regarding the time for replacement through a user output device. In various embodiments, the control circuit can calculate a time for servicing of the system and/or filter elements thereof based on calculated real time values for air volume and/or air velocity.

Beyond the operations discussed above, monitoring systems herein (including the control circuit thereof and/or other circuits or components with processing capabilities) can be configured to execute various operations including various operations on data from sensors including, but not limited to averaging, time-averaging, statistical analysis, normalizing, aggregating, sorting, deleting, traversing, transforming, condensing (such as eliminating selected data and/or converting the data to a less granular form), compressing (such as using a compression algorithm), merging, inserting, time-stamping, filtering, discarding outliers, calculating trends and trendlines (linear, logarithmic, polynomial, power, exponential, moving average, etc.), predicting filtration system component (valves, timing boards, filter elements, etc.) EOL (end of life), identifying an EOL condition, predicting performance, predicting costs associated with replacing filtration system components vs. not-replacing components, normalizing data/signals, executing peak detection and/or peak fitting algorithms, and the like. Fourier analysis can decompose a physical signal into a number of discrete frequencies, or a spectrum of frequencies over a continuous range. In various embodiments herein, operations on signals/data can include Fast Fourier Transformations (FFT) to convert data/signals from a time domain to a frequency domain. Other operations on signals/data here can include spectral estimation, frequency domain analysis, calculation of root mean square acceleration value (G_{RMS}), calculation of acceleration spectral density, power spectral densities, Fourier series, Z transforms, resonant frequency determination, harmonic frequency determination, and the like. It will be appreciated that while various of the operations described herein (such as Fast Fourier transforms) can be performed by general-purpose microprocessors, they can also be performed more efficiently by digital signal processors (DSPs) which can, in some embodiments, be integrated with the control circuit or may exist as separate, discrete components.

### Methods

Many different methods are contemplated herein, including, but not limited to, methods of monitoring filtration systems or industrial dust collectors, methods of detecting malfunctioning systems, methods of determining the need for servicing or maintenance of such systems, and the like. Aspects of system/device operation described elsewhere herein can be performed as operations of one or more methods in accordance with various embodiments herein.

In various embodiments, operations described herein and/or method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

In an embodiment, a method of monitoring industrial dust collectors is included. The method can include storing a previously measured air volume value and/or air velocity value, measuring real time pressure values in an area in fluid communication with an industrial air collector, and calculating real time air volume values and/or real time air velocity values using the real time pressure values and the previously measured air volume value and/or air velocity value.

In an embodiment, the method can further include measuring real time pressure values within a main duct portion of the industrial dust collector. In an embodiment, the method can further include measuring real time pressure values within a branch of a main duct or other part of the industrial dust collector.

In an embodiment, the method can further include measuring real time pressure values within a duct of the industrial dust collector upstream from an air filter. In an embodiment, the method can further include measuring real time pressure values within a duct of the industrial dust collector or in fluid communication with the industrial dust collector having a diameter of 4 to 48 inches.

In an embodiment of the method, a pressure sensor is mounted on, mounted in, and/or mounted in fluid communication with the industrial dust collector.

In an embodiment, the method can further include measuring pressure within air ducts associated with different industrial air collectors.

In an embodiment, the method can further include issuing an alert if the real time air volume values and/or real time air velocity values are outside of a target range. In an embodiment, the method can further include receiving input from a system user regarding a target range. In an embodiment, the method can further include issuing an alert if the real time air volume values and/or real time air velocity values are outside of a target range regardless of relative airflow values.

In an embodiment, methods herein can further include transmitting real time data to a remote computing resource. In an embodiment, the real time data can include at least one selected from the group consisting of real time pressure values, real time air volume values, and real time air velocity values.

Aspects have been described with reference to various specific and preferred embodiments and techniques. However, it should be understood that many variations and modifications may be made while remaining within the spirit and scope herein. As such, the embodiments described herein are not intended to be exhaustive or to limit the invention to the precise forms disclosed in the following detailed description. Rather, the embodiments are chosen and described so that others skilled in the art can appreciate and understand the principles and practices.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

1. A monitoring system for industrial dust collectors comprising:
a pressure sensor; and
a control circuit, wherein the control circuit is in signal communication with the pressure sensor;
wherein the monitoring system stores a previously measured air volume value and/or air velocity value; and
wherein the monitoring system calculates real time air volume values and/or real time air velocity values using data from the pressure sensor and the previously measured air volume value and/or air velocity value.

2. The monitoring system of claim 1, wherein the monitoring system calculates a real time value for air volume and/or air velocity by multiplying the previously measured air volume value and/or air velocity value by the square of the quotient of a current relative airflow value divided by a relative airflow value measured at the time of the previously measured air volume and/or air velocity, wherein relative airflow values are derived using data from the pressure sensor.

3. The monitoring system of claim 1, wherein the monitoring system calculates a real time value for air volume and/or air velocity by multiplying the previously measured air volume value and/or air velocity value by the square of the quotient of a current pressure value divided by a pressure value measured at the time of the previously measured air volume and/or air velocity.

4. The monitoring system of claim 1, the pressure sensor comprising a static pressure sensor.

5. The monitoring system of claim 4, wherein the static pressure sensor is configured to measure pressure within a main duct portion of the industrial dust collector.

6. The monitoring system of claim 4, wherein the static pressure sensor is configured to measure pressure within a branch off of a main duct of the industrial dust collector.

7. The monitoring system of claim 4, wherein the static pressure sensor is configured to measure pressure within a duct of the industrial dust collector upstream from an air filter.

8. The monitoring system of claim 4, wherein the static pressure sensor is configured to measure pressure within a duct of the industrial dust collector or in fluid communication with the industrial dust collector having a diameter of 4 to 48 inches.

9. The monitoring system of claim 1, wherein the pressure sensor is configured to be mounted on, mounted in, and/or mounted in fluid communication with an industrial dust collector.

10. The monitoring system of claim 1, the pressure sensor comprising a plurality of static pressure sensors, wherein the plurality of static pressure sensors are configured to measure pressure within air ducts associated with different industrial air collectors.

11. The monitoring system of claim 1, wherein the monitoring system is configured to issue an alert if the real time air volume values and/or real time air velocity values are outside of a target range.

12. The monitoring system of claim 11, wherein the system is configured to receive input from a system user regarding the target range.

13. The monitoring system of claim 1, wherein the monitoring system is configured to issue an alert if the real time air volume values and/or real time air velocity values are outside of a target range regardless of relative airflow values.

14. The monitoring system of claim 1, wherein the previously measured air volume and/or air velocity is input into the system based on a measurement taken manually.

15. The monitoring system of claim 1, wherein the previously measured air volume and/or air velocity is input into the system based on a measurement taken using at least one of a pitot tube, a vane anemometer, or a hotwire anemometer.

16. The monitoring system of claim 1, wherein the monitoring system is configured to transmit real time data to a remote computing resource.

17. The monitoring system of claim 16, the real time data comprising at least one selected from the group consisting of real time pressure data, real time air volume values, and real time air velocity values.

18. The monitoring system of claim 1, wherein the real time air volume values are in the range of 500 cfm to 50,000 cfm.

19. The monitoring system of claim 1, wherein the pressure sensor and the control circuit are co-located with an industrial dust collector being monitored.

20. A method of monitoring industrial dust collectors comprising:
storing a previously measured air volume value and/or air velocity value;
measuring real time pressure values in an area in fluid communication with an industrial air collector; and
calculating real time air volume values and/or real time air velocity values using the real time pressure values and the previously measured air volume value and/or air velocity value.
